(19) United States
(12) Patent Application Publication
(10) Pub. No.: US 2025/0046197 A1
(43) Pub. Date: Feb. 6, 2025

(54) GENERATING A FLIGHT PATH WHEN THE UAV IS OFFLINE BASED ON TERRAIN DATA

(71) Applicant: Microavia International Limited, Dublin (IE)

(72) Inventors: Miguel Roig Blinov, Dubai (AE); Stanislav Kashchenko, Dubai (AE); Michael Gevlich, Dubai (AE)

(21) Appl. No.: 18/365,298

(22) Filed: Aug. 4, 2023

(51) Int. Cl. G08G 5/00

(52) U.S. Cl. CPC G08G 5/0039; G08G 5/0086

(57) ABSTRACT

Systems and methods for generating flight plans for an unmanned aerial vehicle (UAV). A new flight plan is built for a UAV based on terrain data after a first flight plan is interrupted. The new flight plan is based on terrain data, where the level of detail and size of the terrain data is optimized for resource efficiency. Onboard battery levels are also factored into the calculation of the new path.

### TECHNICAL FIELD

The disclosure relates to the area of unmanned aerial vehicles (UAVs) and systems that increase UAVs operation safety. More specifically, the disclosure relates to flight paths for UAVs.

### BACKGROUND

The technical problem addressed by this disclosure is the need for an efficient and reliable method for generating the shortest path for an unmanned aerial vehicle (UAV) to a designated point, taking into account the terrain data and various factors such as potential obstacles, no-fly zones, connectivity issues and level of battery.

### SUMMARY

Embodiments described herein provide solutions that allows for automatic return to a landing point or mission from any point, which is highly dependent on the terrain relief, while also enabling the operator to interrupt the mission and switch to manual mode as needed, with the ability to fly the UAV to a designated point while still considering the surrounding terrain and other relevant factors.

An optimal path to a point is generated for a UAV while the UAV is in flight and controlled by an operator. The UAV has an onboard computer with a processor and memory and includes a connection for communication. The UAV detects a command to enter into a manual mode and loads terrain data into the UAV's memory. The UAV then detects an event while in manual mode. For example, the UAV can include a detector for receiving a command and/or an event while in manual mode. The detector can be implemented by the processor and configured to monitor commands received by the UAV, monitor UAV operation or UAV's sensor data. In an embodiment, the detector is not activated until the UAV enters manual mode. Once in manual mode, the detector becomes active and can detect specific events or commands, enabling the UAV to respond accordingly, such as changing flight paths or initiating predefined actions.

In an embodiment, a method for generating an optimal path to a point for a UAV in flight and controlled by an operator, the UAV comprising a processor and a memory and including a connection for communication, includes detecting a command to enter into a manual mode; loading terrain data into the memory; detecting by the UAV an event while in the manual mode; identifying a point based on the detected event; and generating an optimal path to the point based on the terrain data loaded into the memory.

In one aspect, the event detected by the UAV includes at least one of: a command, issued by the operator, to return to a home landing point; a command, issued by the operator, to return to a mission point of a mission that was interrupted; a command to return to a home landing point issued automatically by the UAV after losing connection; a command to return to a mission point where a mission was interrupted issued automatically by the UAV after losing connection; a command to return to an ELS (Emergency Landing Spot) issued by the operator or automatically by the UAV after losing connection; a command to return to ELS issued by the operator or automatically by the UAV when battery level is low to return to a predetermined landing point; a command to return to a last point before the connection was lost; or a command to generate a shortest path to the home landing point issued automatically by the UAV every T minutes after entering the manual mode.

In one aspect, the point includes at least one of: a landing point; a mission point where the mission was interrupted; an ELS point; a last point before the connection was lost; or a last point where a last shortest path was calculated.

In one aspect, the terrain data includes at least one of: a cloud of points; a terrain slice; or full terrain map of a predefined radius from the point.

In one aspect, a method further includes downloading terrain data only in sufficient detail required to generate an optimal path to the point.

In one aspect, a method further includes deleting terrain data that is not needed for generating an optimal path to the point.

In one aspect, generating an optimal path to the point based on terrain data loaded during the flight is done while the UAV is operating beyond visual line of sight and without connection with the operator.

In one aspect, generating an optimal path to the point based on the terrain data uses no-fly zones preloaded into the UAV's memory.

In one aspect, loading terrain data includes low-level digitalization of terrain data of a physical area.

In one aspect, a method further includes pre-processing the terrain data to reduce size for storage and reformatting for retrieval.

In one aspect, the terrain data is automatically updated or refreshed based on changing conditions, new data sources, and environmental data from one or more UAV sensors comprising video, photo, thermal, or lidar.

In one aspect, a method further includes adjusting the flight path based on real-time feedback from sensors comprising wind speed and direction, including by calculating an optimal path to the point.

In one aspect, a method further includes dynamically adjusting the level of terrain detail based on available computing power or memory.

In one aspect, a method further includes generating a machine learning model configured to generate an optimal path based on one or more of historical flight data, environmental conditions, and mission objectives.

In an embodiment, a system for generating an optimal path to a point for a UAV in flight, the UAV controlled by an operator, includes a UAV including a processor and memory and having a connection for communication; a detector onboard the UAV for receiving a command to enter into a manual mode and detecting an event while in the manual mode; terrain data loaded into the memory; and instructions that, when executed by the processor, identify a point based on the detected event and generate an optimal path to the point based on the terrain data loaded into the memory.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a flowchart of a method for building a UAV flight path, according to an embodiment.

FIG. 2 is a block diagram of calculation of alternative flight paths for a UAV over a given terrain, according to an embodiment.

FIG. 3 is a block diagram of a system whereby terrain data is communicated to UAV, according to an embodiment.

FIG. 4A is a block diagram of a flight path for a UAV over a given terrain, according to an embodiment.

FIG. 4B is a block diagram of a flight path for a UAV over a given terrain, according to an embodiment.

FIG. 4C is a block diagram of a flight path for a UAV over a given terrain, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

In operation of a UAV, the UAV's flight plan is preloaded into a UAV's onboard computer and the UAV begins its flight. At some point along the trajectory, the mission is interrupted. For example, the operator may interrupt the mission and switch the UAV to manual control. In manual mode and, with a connection available, the UAV can fly to a specific point of interest or perform other tasks, such as searching for a missing person in a remote environment. The UAV may then be switched to resume the original flight plan from its current location, to return to the point where the original flight plan was interrupted, or to go back to the launch point. Or the UAV may activate its Emergency Landing Spot (ELS).

The UAV's connection in these examples may be one or more of various types. For example, UAVs typically have a wireless connection with a remote controller operated by a pilot. The remote controller communicates with the UAV using radio frequencies or other wireless technologies, enabling the operator to send control commands to maneuver the drone, adjust its flight parameters, and control auxiliary features like onboard cameras. UAVs may also establish a bidirectional telemetry and command link with a ground station or control system, sometimes referred to as UTM. In the context of UAVs, UTM stands for Unmanned Aircraft Systems (UAS) Traffic Management. UTM for UAVs generally refers to the infrastructure, systems, and procedures put in place to manage the increasing number of unmanned aircraft, such as UAV-drones, operating in common airspace. UTM for UAVs typically involves a combination of technologies such as geofencing, remote identification, communication protocols, and data exchange between drones and UTM service providers. These systems help ensure that drones operate within authorized areas, avoid conflicts with other airspace users, and comply with regulations and safety guidelines.

This bidirectional telemetry and command link allows real-time data transmission from the UAV to the UTM. Telemetry data includes information such as GPS location, altitude, speed, battery status, sensor readings, and flight parameters. The command link enables UTM to send control commands, update flight plans, and receive feedback from the UAV. Alternatively, the UAV can rely on satellite-based navigation systems, such as GPS (Global Positioning System), GLONASS, or Galileo, to determine its position, velocity, and altitude. In an embodiment, the UAV is equipped with Wi-Fi or cellular capabilities to connect to wireless networks to access the internet, stream video feeds, transmit telemetry data, or communicate with cloud-based services. Wireless network connectivity enables enhanced capabilities like real-time video transmission, remote control, mission planning, and integration with cloud services for data storage, analytics, and collaboration. In some embodiments, the UAV communicates directly with other UAVs to enable coordinated operations, collaborative missions, or swarm intelligence. UAV to UAV communication can be established using wireless networks or dedicated protocols, allowing the UAV to exchange information, share situational awareness, coordinate flight paths, and collaborate on tasks.

The UAV has an onboard computer comprising a processor and memory. The UAV also has an onboard battery for storing and supplying the power to the UAV's motors, flight-control system, onboard electronics, and other components. Examples of onboard batteries are rechargeable lithium-ion (Li-ion) or lithium polymer (LiPo) batteries due to their high energy density and power-to-weight ratio. UAV batteries are designed to provide a specific voltage output, such as 3.7V, 7.4V, 11.1V, or 14.8V. The voltage requirement depends on the drone's electrical system and motor configuration. The onboard battery comprises one or multiple cells connected in series to achieve the desired voltage. The UAV's battery capacity is measured in milliampere-hours (mAh) or ampere-hours (Ah). Higher-capacity batteries can provide longer flight times, but at the cost of increased weight. The UAV's battery capacity is a factor in determining the UAV's flight endurance and thus also a factor in calculating flight plans.

The trajectory of automatic return to the flight plan, or the UAV's return to the landing point or ELS from an arbitrary point, is determined by a number of factors. These include the terrain data loaded into the UAV's onboard computer's memory, the presence of a connection, and other parameters, including the current battery level. In embodiments, terrain data is preloaded before launch into the UAV's onboard computer with details needed for the mission. In embodiments, terrain data can take the form of a point cloud or a relief profile. In embodiments, terrain data can be communicated to the UAV during UAV flight operation (e.g. mid-flight).

When the UAV is switched to manual control during a mission, terrain data is loaded into the UAV's onboard computer's memory. This can include terrain data of a certain radius from the current position, terrain data for the terrain where the UAV is heading, or predictively generated terrain data for the area where the UAV is expected to fly. This terrain data must be of a sufficient scale to calculate the shortest path to the landing point, ELS, or the point where the mission was interrupted.

In an embodiment, terrain data includes digitized physical data. In an embodiment, loading terrain data includes low-level digitalization of terrain data for a physical area. The low-level digitalization involves capturing essential topological information of the terrain, such as elevation points, basic geographical features, and major landmarks, while omitting fine-grained details. This approach optimizes memory usage and processing resources, enabling the UAV to perform efficient path calculations and make navigation decisions based on key terrain characteristics.

In an embodiment, terrain data downloading can be limited by whether sufficient detail is provided. For example, sufficient detail for downloading terrain data can be based on a dynamic calculation that takes into account the UAV's flight parameters, mission objectives, and available resources. The UAV's onboard processor evaluates the distance to the designated point, the complexity of the terrain, and the UAV's memory capacity. It then compares this information against predefined thresholds or criteria set by the operator or system configuration. If the calculated level of detail exceeds the set thresholds, the UAV downloads terrain data with a reduced level of detail, optimizing memory usage and transmission time while still ensuring accurate path planning. The UAV maintains real-time awareness of its position and environment, continuously adjusting the level of detail to meet the specific requirements of the current mission.

In an embodiment, UAV's onboard processor can be further configured to delete terrain data that is not needed for generating an optimal path to the point. In an embodiment, the determination of terrain data that is not needed is performed by the UAV's onboard processor based on its current flight plan and the relevant terrain information required for the mission. As the UAV progresses along its flight path, it continuously evaluates the terrain data stored in its memory, considering upcoming waypoints, obstacles, and flight corridors. If certain terrain data is no longer relevant to the current flight plan, for example, if the UAV has already passed through a specific area, or if the terrain data is not required for the remaining part of the mission, the UAV automatically deletes the unnecessary data to free up memory space. The decision to delete data is based on real-time mission requirements and the UAV's positioning, ensuring that the memory is optimally utilized for accurate and efficient path planning. This process enables the UAV to adapt to changing flight conditions and reduce memory usage as the mission progresses, without compromising the accuracy of its path calculations.

When the UAV is switched to the mode of returning to the mission flight path or returning to the landing point or ELS, the shortest trajectory to the necessary point is calculated by the UAV's onboard computer.

In case of a lack of connection at the UAV's current position, the UAV automatically plots a path to return to the landing point, the point where the mission was interrupted, or the ELS. In an embodiment, the battery level is used as a parameter for automatic point selection.

Even with current information storage technologies, memory limitation is a significant issue for the UAV. With the increasing accuracy of data collection methods such as relief, photography, LiDAR scanning, and improved video recording, the volume of data that the UAV needs to store may be relatively large. Onboard memory devices available for the UAV are limited in size and weight by the UAV's design parameters. Computational power limitations also affect the UAV's design. Processing a large volume of data requires more computational power. However, this computational power requires a proportionately large power supply. The UAV's performance is limited by its battery life so available processors are limited to those that can be effective within the limitations of the UAV's battery economy.

The channel for data transmission is also limited to certain speeds, which restricts the volume of data that can be transmitted in a given time. Increasing the transmission speed can result in reduced channel stability and range.

Another restraint on path building occurs when the UAV operates in areas without operator or UTM connectivity. In such cases, the UAV's calculations may be limited to onboard data or to data collected from sources other than the operator.

Although terrain data is an important factor in path building, the level of detail for the terrain data may be varied according to need. For example, terrain data can be stored only at the level of detail required for the current or anticipated task, taking into account the current or anticipated memory usage.

In an embodiment, the level of detail of the terrain data can be increased and/or decreased. The UAV does this by reducing the level of detail of the terrain data in its memory by removing or grouping values. Alternatively, the UAV can request an increase in the level of detail. In this case, if there is less detailed terrain data and the points of the less detailed terrain data match the points of the more detailed terrain data, only the missing points of the more detailed terrain data will be requested or obtained, taking into account the current or anticipated memory usage. The same approach can be used for the level of detail of flight corridors and areas with special flight rules. If the needs or anticipated needs change in the future, the terrain data can be loaded at the required level of detail. If the current level of detail is expected to be useful in the future, it can temporarily exist in parallel with data of another level of detail. The UAV itself can also reduce the level of detail of the terrain data to optimize memory usage or speed up processing. When requesting data, the current memory usage can be taken into account.

In an embodiment, the level of detail of the terrain data can be adjusted based on various factors such as terrain topology, presence of obstacles, wind conditions, and telemetry data from the UAV. For example, in a scenario with flat terrain, no obstacles, and consistent wind conditions, the UAV may only require two points for path calculation. However, when there are obstacles present, and wind conditions vary at different heights and locations, the UAV may need to increase the level of detail by using more points in the terrain data to accurately plan its trajectory. The number of required points can be determined based on the complexity of the terrain, the distance to be traveled, and other telemetry data such as wind strength and direction, battery status, and power consumption dynamics. By incorporating different coefficients with these parameters, the UAV can calculate not only the shortest route to the landing point but also an optimal path that takes into account various real-world conditions and constraints. This adaptive approach ensures efficient memory usage and faster processing while still considering all relevant factors for safe and effective UAV operation.

Processing terrain data is also performed at different levels of detail. For example, pathfinding can be performed at any level of detail. Terrain data is transmitted or requested at the level of detail required for the current or anticipated task, taking into account the current or anticipated memory usage. The terrain data can also include point clouds. The level of detail comprises not only the density of points, but also their shape. The shape can be simplified to a low-polygon version or to shapes such as spheres and cuboids depending on the level of detail needed. Light Detection and Ranging (Lidar) can also be a source of data that can be compressed and processed for use in the same flight.

The UAV can leverage machine learning or artificial intelligence algorithms to improve the accuracy and efficiency of the shortest path generation process, based on factors such as historical flight data, environmental conditions, and mission objectives. For example, a machine learning model can be trained on data associated with the UAV. In an embodiment, the aforementioned data can be converted into vectors for training the machine learning model. In an embodiment, the machine learning model can be communicated to the UAV for use in path generation. In another embodiment, a machine learning model can exist remote from the UAV, but used to communicate path generation commands to the UAV.

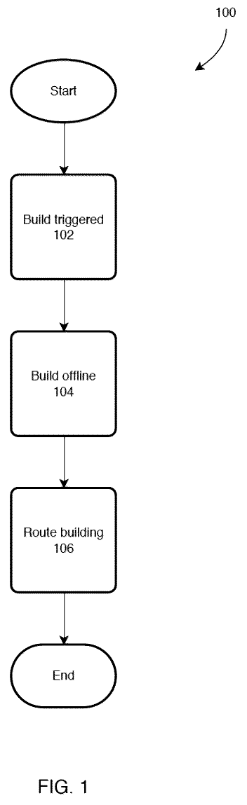

Referring to FIG. 1, a flowchart of a method 100 for building a flight path or route after the start of a UAV flight is depicted, according to an embodiment. The build is triggered at 102 by an interruption in the UAV's original flight path. A determination is made at 104 that the UAV has lost connection and a new path will be built offline. In particular, building a new path offline means that the UAV is not in communication with another device. At 106, a new flight plan is built and replaces the original plan that was in effect before being interrupted. At 106, data about terrain and current battery levels are used by the UAV's onboard computer to build the new flight plan.

In an embodiment, two-dimensional slices of terrain data are uploaded for a path to the landing point for a certain period of time or distance. In an alternative embodiment, a strip of a point cloud or landscape of a certain width from the drone to the landing point is loaded for a certain period of time or distance. In another embodiment, a point cloud or landscape is loaded such that the segment connecting the drone and the landing point is always located inside the loaded point cloud or above the loaded terrain.

In an embodiment, though not depicted in FIG. 1, the method 100 includes an operation of pre-processing the terrain data to optimize its storage and retrieval. Pre-processing can include applying various techniques to reduce the size of the terrain data while preserving essential information for path planning. This reduction in data size helps to minimize the memory footprint on the UAV's onboard computer, which is crucial for efficient operation during flight. Additionally, the terrain data is reformatted in a manner that allows for quick and seamless retrieval when needed for path calculations. By performing pre-processing, the UAV can efficiently manage its memory resources while still ensuring access to critical terrain information during its missions. Pre-processing can be conducted prior to the build triggered at 102.

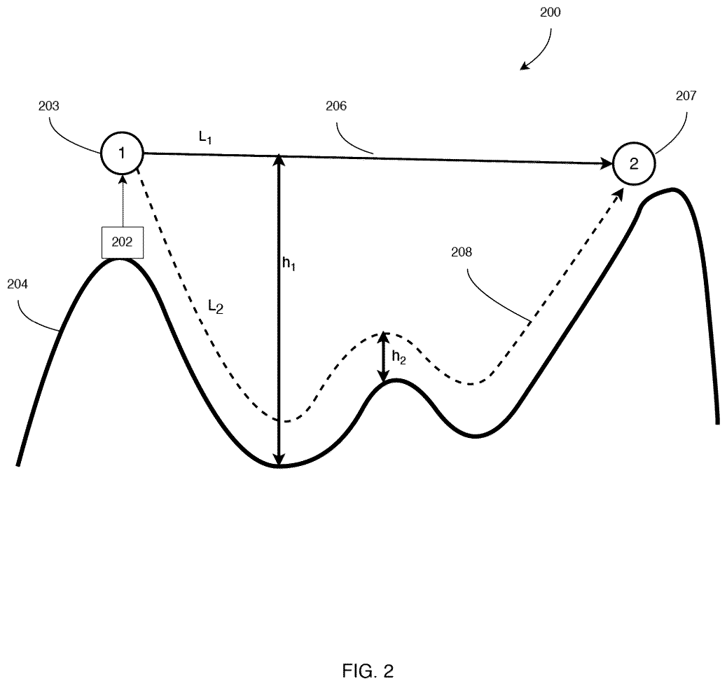

Referring to FIG. 2, a block diagram of alternate flight paths 200 over terrain with high and low points is depicted, according to an embodiment. For example, UAV takes off from launch point 202 and reaches elevation 203 (point 1) over terrain 204. Path 206 is a direct path of length L1 at height h1 from starting point 203 (point 1) and ending point 207 (point 2). Path 208 is a path of length L2 from starting point 203 to ending point 207 at height h2, where h2 is a constant height above terrain 204.

Path 206 (L1) corresponds to a direct path from point 1 to point 2. Path 208 (L2) corresponds to the path that requires the least amount of elevation of the UAV above terrain 204.

The optimal path between points 1 and 2 means the shortest path between 2 points, taking into account the terrain, where the sum of the length of the path segments is the smallest. The optimal path is also based on battery, distance, path load, weather conditions, and so on. Battery optimality may partially include all other parameters, since, for example, the shortest path may be battery optimal if the rate of climb is sufficiently low. In the event that other aircraft are flying along a given path, this path may not be battery-optimal since it may be necessary to spend extra time in flight to avoid other aircraft. Further, if a strong wind is blowing, in order not to waste battery fighting against the wind, the optimal path will be lower, between mountains, houses, and other terrain features. Although distance optimality strongly correlates to the shortest path, the path that is actually optimal is offset by load, meaning that there are no or almost no other aircraft during the passage of a particular section of the path.

In an embodiment, a path between points 1 and 2 is calculated by the UAV's onboard computer, while offline (e.g. not in communication with another device), in view of path distance, modified terrain data for the path, and anticipated power requirements for the path. In an alternative embodiment, the modified terrain detail comprises the minimum amount of data required to calculate a path to point 2. In other embodiments, the level of detail of the terrain data is enhanced and used in the path calculation to determine the specific nature of the terrain, including whether the terrain comprises natural obstacles such as trees and hills or other obstacles such as buildings or powerlines.

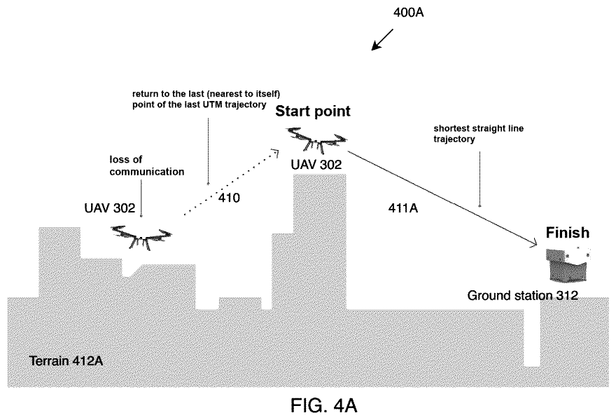

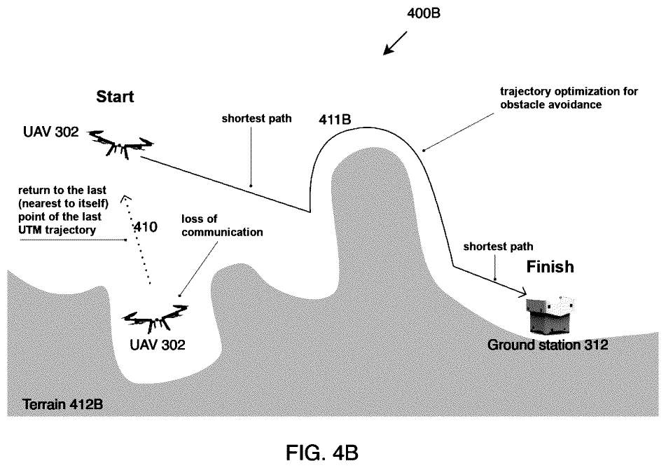

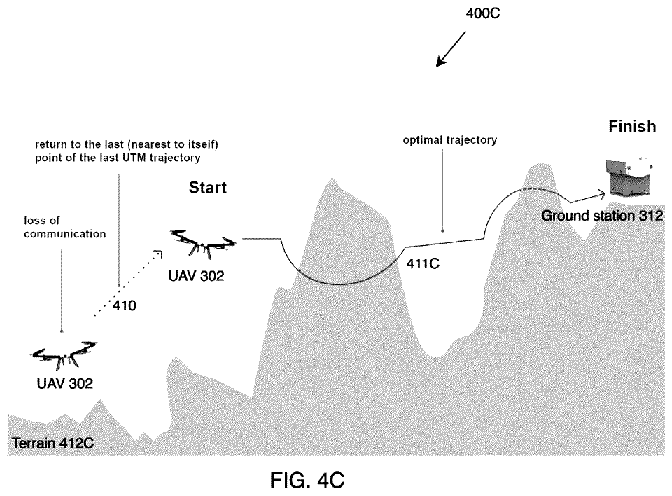

Referring to FIG. 4A, a block diagram of a flight path 400A for a UAV 302 over a given terrain 412A is depicted, according to an embodiment. For example, upon loss of communication the UAV 302 determines the last (e.g. nearest to itself) point of the last UTM trajectory at 410. The UAV 302 further determines a trajectory 411A to the ground station 312 from the last point of the last UTM trajectory. In this example, the trajectory 411A is the shortest straight line to the ground station 312.

Referring to FIG. 4B, a block diagram of a flight path 412B for a UAV 302 over a given terrain 412B is depicted, according to an embodiment. For example, upon loss of communication the UAV 302 determines the last (e.g. nearest to itself) point of the last UTM trajectory at 410. The UAV 302 further determines a trajectory 411B to the ground station 312 from the last point of the last UTM trajectory. In this example, the trajectory 411B is the shortest straight line, an optimization for obstacle avoidance, and a subsequent shortest path after the obstacle to the ground station 312. The UAV 302 further determines a trajectory 411C to the ground station 312 from the last point of the last UTM trajectory. In this example, the trajectory 411C is the shortest straight line, an optimization for obstacle avoidance, a subsequent shortest path after the obstacle, and a subsequent second optimization for a second obstacle avoidance to the ground station 312.

Referring to FIG. 4C, a block diagram of a flight path 412C for a UAV 302 over a given terrain 41C is depicted, according to an embodiment. For example, upon loss of communication the UAV 302 determines the last (e.g. nearest to itself) point of the last UTM trajectory at 410.

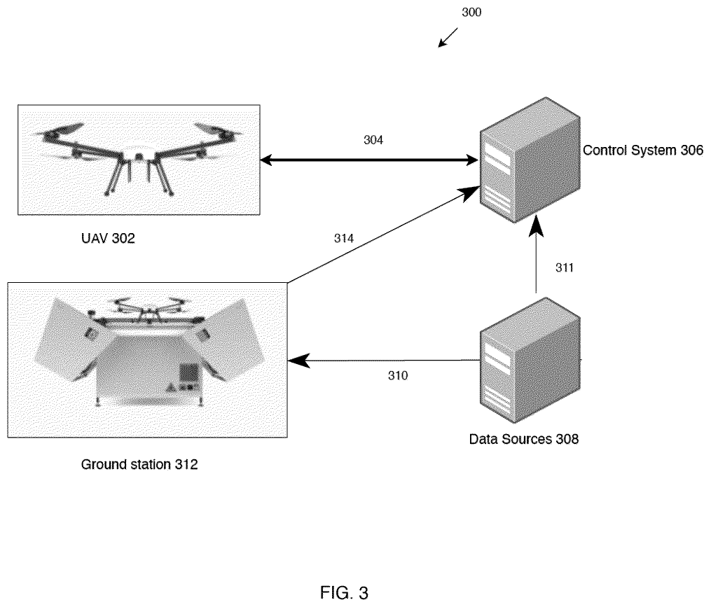

Referring to FIG. 3, a block diagram of a system 300 whereby terrain data is communicated to UAV 302 is depicted, according to an embodiment. As shown in FIG. 3, UAV 302 shares a two-way data stream 304 with control system 306. In an embodiment, control system 306 is a UTM system. Data sources 308 communicate by way of data stream 311 with control system 306 and by way of data stream 310 with ground station 312, which may also serve as a launching point for UAV 302. In an embodiment, data stream 310 comprises weather data. In an alternative embodiment, data stream 311 comprises weather data or maps or both. Ground station 312 communicates with control system 306 by way of data stream 314. UAV 302 receives terrain data from control system 306, which in an embodiment is a UTM server. Control system 306 stores all data and manages UAV 302. Multiple UAVs can be managed by control system 306.

1. A method for generating an optimal path to a point for a UAV in flight and controlled by an operator, the UAV comprising a processor and a memory and including a connection for communication, the method comprising:
detecting a command to enter into a manual mode;
loading terrain data into the memory;
detecting by the UAV an event while in the manual mode;
identifying a point based on the detected event; and
generating an optimal path to the point based on the terrain data loaded into the memory.

2. The method of claim 1, wherein the event detected by the UAV includes at least one of:
a command, issued by the operator, to return to a home landing point;
a command, issued by the operator, to return to a mission point of a mission that was interrupted;
a command to return to a home landing point issued automatically by the UAV after losing connection;
a command to return to a mission point where a mission was interrupted issued automatically by the UAV after losing connection;
a command to return to an ELS (Emergency Landing Spot) issued by the operator or automatically by the UAV after losing connection;
a command to return to ELS issued by the operator or automatically by the UAV when battery level is low to return to a predetermined landing point;
a command to return to a last point before the connection was lost; or
a command to generate a shortest path to the home landing point issued automatically by the UAV every T minutes after entering the manual mode.

3. The method of claim 1, wherein the point includes at least one of:
a landing point;
a mission point where the mission was interrupted;
an ELS point;
a last point before the connection was lost; or
a last point where a last shortest path was calculated.

4. The method of claim 1, wherein the terrain data includes at least one of:
a cloud of points;
a terrain slice; or
full terrain map of a predefined radius from the point.

5. The method of claim 1, further comprising downloading terrain data only in sufficient detail required to generate an optimal path to the point.

6. The method of claim 1, further comprising deleting terrain data that is not needed for generating an optimal path to the point.

7. The method of claim 1, wherein generating an optimal path to the point based on terrain data loaded during the flight is done while the UAV is operating beyond visual line of sight and without connection with the operator.

8. The method of claim 1, wherein generating an optimal path to the point based on the terrain data uses no-fly zones preloaded into the UAV's memory.

9. The method of claim 1, wherein loading terrain data includes low-level digitalization of terrain data of a physical area.

10. The method of claim 1, further comprising pre-processing the terrain data to reduce size for storage and reformatting for retrieval.

11. The method of claim 1, wherein the terrain data is automatically updated or refreshed based on changing conditions, new data sources, and environmental data from one or more UAV sensors comprising video, photo, thermal, or lidar.

12. The method of claim 1, further comprising adjusting the flight path based on real-time feedback from sensors comprising wind speed and direction, including by calculating an optimal path to the point.

13. The method of claim 1, further comprising dynamically adjusting the level of terrain detail based on available computing power or memory.

14. A method of claim 1, further comprising generating a machine learning model configured to generate an optimal path based on one or more of historical flight data, environmental conditions, and mission objectives.

15. A system for generating an optimal path to a point for a UAV in flight, the UAV controlled by an operator, the system comprising:
a UAV including a processor and memory and having a connection for communication;
a detector onboard the UAV for receiving a command to enter into a manual mode and detecting an event while in the manual mode;
terrain data loaded into the memory; and
instructions that, when executed by the processor, identify a point based on the detected event and generate an optimal path to the point based on the terrain data loaded into the memory.

16. The system of claim 15, wherein the event includes at least one of:
a command, issued by the operator, to return to a home landing point;
a command, issued by the operator, to return to a mission point of a mission that was interrupted;
a command to return to a home landing point issued automatically by the UAV after losing connection;
a command to return to a mission point where a mission was interrupted issued automatically by the UAV after losing connection;
a command to return to an ELS (Emergency Landing Spot) issued by the operator or automatically by the UAV after losing connection;
a command to return to ELS issued by the operator or automatically by the UAV when battery level is low to return to a predetermined landing point;
a command to return to a last point before the connection was lost; or
a command to generate a shortest path to the home landing point issued automatically by the UAV every T minutes after entering the manual mode.

17. The system of claim 15, wherein the point includes one of the following:
a landing point;
a mission point where the mission was interrupted;
an ELS point;
a last point before the connection was lost; or
a last point where a last shortest path was calculated.

18. The system of claim 15, wherein the terrain data comprises:
a cloud of points;
a terrain slice; or
full terrain map of a predefined radius from the point.

19. The system of claim 15, wherein the terrain data is downloaded only in sufficient detail required to generate an optimal path to the point.

20. The system of claim 15, wherein the UAV deletes terrain data that is not needed for generating an optimal path to the point.
